(19) United States
(12) Patent Application Publication
(10) Pub. No.: US 2008/0114091 A1
(43) Pub. Date: May 15, 2008

(54) Apparatus and Method for Preparing a UV-Induced Crosslinked Foam

(75) Inventors: Nelson E. Malwitz, Brookfield, CT (US); Natarajan S. Ramesh, Grapevine, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sealed Air Corporation (US)

(21) Appl. No.: 11/560,042

(22) Filed: Nov. 15, 2006

(51) Int. Cl. C08J 3/28; B01L 1/00

(52) U.S. Cl. 522/162; 422/133

(57) ABSTRACT

The present invention provides a method for producing a UV induced crosslinked foam in which a melt stream comprising a thermoplastic polymer, a UV crosslinking agent and a photoinitiator is crosslinked by exposing the melt stream to a source of UV light source prior to extruding the melt through an extrusion die. Exposing the melt stream to UV light causes the photoinitiator to become excited and react with the crosslinking agent to generate a free radical. The thus generated free radical reacts with the thermoplastic polymer to induce crosslinking in the polymer. Crosslinking of the polymer can be done prior to extrusion so that the crosslinking process can be carried out without additional steps and/or without the aid of chemical crosslinking agents. The invention also provides an apparatus for producing a crosslinked foam in which the apparatus includes a UV chamber disposed between the extruder and the die through which UV light can be introduced into the melt stream.

### BACKGROUND OF THE INVENTION

The present invention relates generally to a method and apparatus for producing foamed articles and more particularly to crosslinked foam articles.

Foamed thermoplastic articles are commonly used in a wide variety of applications, for example, thermal insulation, flotation, cushioning, packaging, and the like. In many of theses applications, it is desirable that the foam have a fine cell structure that is both uniform and has a fine structure.

It has been generally been found that crosslinking the polymeric resins before or after extrusion can be used to produce foamed articles having many desirable characteristics. For example, crosslinking the polyolefinic matrix stabilizes the foam expansion process by increasing the extensional viscosity (melt strength) of the polymer and minimizing cell wall collapse. Further, crosslinking may also enhance the physical properties (e.g. tensile strength, elastic recovery, creep, etc.) of the foamed article by establishing a molecular network within the polymer matrix. Higher levels of crosslinking may result in higher tensile, elastic recovery, and creep properties.

Crosslinked foams can be manufactured using a chemical foaming agent, e.g., azodicarbonamide, in combination with crosslinking induced by peroxide decomposition or by irradiation with a high energy source or UV light. In the case of chemical crosslinking, exposure of the foaming agent to elevated temperatures (e.g., >130° C.), causes the foaming agent decomposes into a gas, and the polyolefinic matrix is crosslinked via peroxide decomposition. By achieving an optimum level of tensile properties at elevated temperatures by crosslinking, the decomposed gas is allowed to expand controllably to produce foams with desirable cell sizes. However, in many cases the extruded material needs to be crosslinked prior to activating the foaming agent so that the polyolefinic matrix has sufficient strength to expand without rupture or destruction of the cells. For instance, many polyolefinic resins such as linear low density polyethylene (LLDPE), ethylene vinyl acetate (EVA) and metallocene catalyzed polyethylenes have relatively poor melt strength and as a result generally need to be crosslinked prior to activation of the foaming agent.

Several methods are known for crosslinking polyolefinic materials. Some common methods include the use of free radicals (e.g., chemical crosslinking or high energy irradiation, such as electron beam irradiation) to initiate crosslinking. However, chemical crosslinking methods generally have low heat-efficiency, long crosslinking times and relatively complicated process requirements because of the conditions that are critical to chemical crosslinking reactions. Similarly, high energy irradiation also have several shortcomings including the cost of the equipment, complicated operation, multiple steps, and processing technologies, and safety concerns that are associated with the used of high energy radiation.

Photocrosslinking of olefins, such as polyethylene, using UV radiation has also been investigated as a possible method of initiating crosslinking. However, UV crosslinking of olefin materials has not widely been commercially accepted because of difficulties in creating a homogeneously crosslinked foam. Problems in crosslinking with UV radiation arise, at least in part, due to the difficulty of crosslinking thick samples of the foam sample because of the poor penetration of the UV light into the sample and slow reaction rates for photocrosslinking. As a result, UV photocrosslinking has generally been limited to photocuring applications and applications where the surface to be crosslinked is relatively thin, e.g., films that are less than about 0.3 mm thick. Thus, photocrosslinking with UV light has not been commonly used in the crosslinking of polyolefin foams.

The use of UV light or high energy irradiation to induce crosslinking has generally involved extruding a melt stream of a thermoplastic polymer to produce a sheet material or shaped article, followed by irradiating the sheet/shaped article with UV light or high energy radiation to induce crosslinking. Once a sufficient amount of crosslinking has occurred, the foaming agent can be activated so that the irradiated sample expands to produce a foam having a cellular structure. As a result, processes of preparing a crosslinked foam have generally required a two-step process in which the resin matrix is crosslinked prior to activating the foaming agent. The need for separate crosslinking and foaming steps generally increase the cost and inefficiencies of the processes.

Thus, there still exits a need for a method and apparatus for preparing a crosslinked foam that provides an efficient and cost effective means for crosslinking the foam while permitting the resin matrix to be crosslinked and expanded without the need for performing such steps as distinct process steps

### BRIEF SUMMARY OF THE INVENTION

In one embodiment, the present invention provides a method for producing a UV induced crosslinked foam in which a melt stream comprising a thermoplastic polymer, a UV crosslinking agent and a photoinitiator is crosslinked by exposing the melt stream to a source of UV light source prior to extruding the melt through an extrusion die. Exposing the melt stream to UV light causes the photoinitiator to become excited and react with the UV crosslinking agent to generate a free radical. The thus generated free radical of the crosslinking agent reacts with the thermoplastic polymer to induce crosslinking between the polymer chains. Crosslinking of the thermoplastic polymer can be done prior to extrusion of the melt stream so that the crosslinking process can be carried out without additional steps and/or without the aid of chemical crosslinking agents.

In a further aspect, the invention is directed to an apparatus for producing a UV crosslinked foam comprising an extruder, a die, and a UV chamber disposed between the die and the extruder. A melt stream comprising a thermoplastic polymer, a photoinitiator, and a crosslinking agent are mixed in the extruder to form a homogeneous melt stream. The melt stream is forced out of the extruder and introduced into the UV chamber. UV light is introduced into the melt stream while in the UV chamber. In one embodiment, the UV chamber includes a UV transparent window, such as quartz, through UV light can be directed into the melt stream through the UV transparent window. As noted above, exposing the melt stream to UV light causes the photoinitiator to become excited and interact with the crosslinking agent to generate a free radical. The thus generated crosslinking agent having a free radical interacts with the thermoplastic polymer to induce crosslinking in the polymer.

In one embodiment, the degree of crosslinking in the polymer can be controlled by controlling the degree of UV light to which the melt stream is exposed. In one embodiment, the melt stream is exposed to UV light at a desired wavelength range, intensity and residence time sufficient to provide the melt stream with a dose of UV light that is sufficient to induce light crosslinking within the melt stream.

Thus, the invention provides a method for producing a UV induced crosslinked foam in which the crosslinking and foaming steps can be combined in a single step process.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic illustration of an apparatus for preparing a UV-induced crosslinked foam;

FIG. 2 is a cross-sectional side view of the apparatus depicted in FIG. 1;

FIG. 3 is a cross-sectional side view of the UV chamber depicted in FIGS. 1 and 2 illustrating the internal components of the UV chamber; and

FIG. 4 is a cross-sectional side view of a UV chamber having a LED light source disposed in the UV chamber.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

In one aspect, the present invention provides an apparatus and associated method for producing a UV induced crosslinked foam in which a melt stream comprising a thermoplastic polymer, a UV crosslinking agent, also commonly referred to as a crosslinking aid, and a photoinitiator is crosslinked by exposing the melt stream to a source of UV light source prior to extruding the melt through an extrusion die. While not wishing to be bound by theory, it is believed that absorption of UV light causes electrons in the photoinitiator to transition from a ground state into an excited state. The thus excited photoinitiator can then participate in bimolecular reactions wherein the excited state of the photoinitiator interacts with the crosslinking agent to generate a free radical in the crosslinking agent. The free radical of the crosslinking agent is capable of reacting with the thermoplastic polymer to produce a crosslinked polymer melt. In one embodiment, a foaming agent can also be introduced into the polymeric melt prior to die extrusion so that upon being extruded through the die, the polymeric melt can expand to form a foamed article. In this embodiment, the melt stream is maintained in a first high pressure domain so that the foaming agent is substantially prevented from expanding. The polymeric melt is then extruded through the extrusion die into a second pressure domain of relatively lower pressure (e.g., atmospheric pressure) that causes the foaming agent to expand and form a foamed article. As a result, the apparatus and method permit the extrusion of crosslinked foams in a one-step process without having to perform post extrusion crosslinking and/or foaming steps.

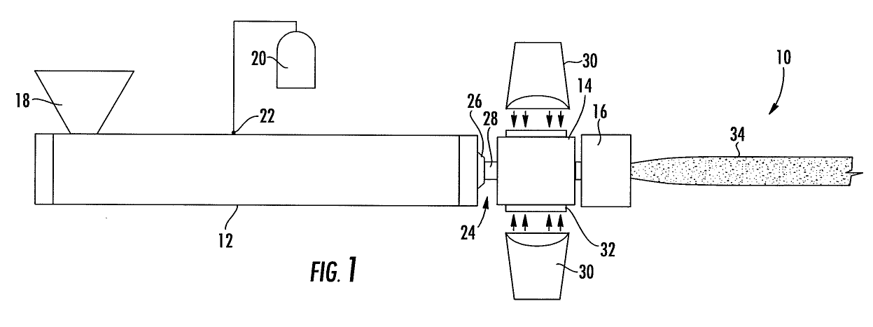

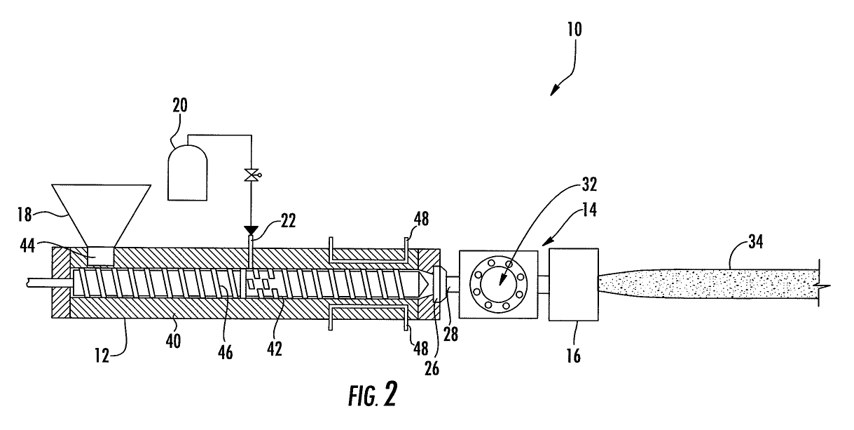

With reference to FIGS. 1 and 2, an apparatus for producing a UV crosslinked foam is illustrated and broadly designated by reference number 10. The apparatus 10 includes an extruder 12, a UV chamber 14, and an extrusion die 16. Extruder 12 can be a conventional foam extruder, such as a single or twin screw extruder. Thermoplastic polymeric resin(s) and other additives including the photoinitiator and crosslinking agent are introduced into the extruder via an inlet, such as a hopper 18. A foaming agent may also be introduced into the extruder from a source 20 via inject port 22. In the extruder, the melt stream, including the foaming agent, are heated and thoroughly mixed together to form a homogeneous mixture. As noted above, the mixture may be extruded under sufficient pressure to prevent foaming of the melt stream until the mixture is extruded through the die. After passing through the UV chamber 14, the melt stream is fed into die 16 and extruded through the die into a zone of lower pressure where the melt stream expands to form a crosslinked foam 34.

The extruder 12 includes an outlet 24 through which the melt stream is discharged from within the extruder and into UV chamber 14. In the UV chamber, UV light is introduced into the melt stream at it passes through the UV chamber. As noted above, exposure of the melt stream to UV light causes the photoinitiator to be transition into an excited state, which can then interact with the crosslinking agent to form a free radical that reacts with the thermoplastic polymer to induce crosslinking of the thermoplastic polymer. In some embodiments, a flow passageway 28 is disposed between the extruder 12 and UV chamber 14. The apparatus may also include an adapter 26 that can be used to attach the extruder to the flow passageway 28. Alternatively, the UV chamber can be attached directly to the outlet of the extruder.

In one embodiment, the UV light source comprises one or more UV lamps 30 that introduce UV light into the melt stream through UV chamber 14. The UV chamber 14 may include UV transparent windows 32 through which the UV light is introduced into the UV chamber. The apparatus includes a plurality of UV lamps 30 that are position with respect to the UV chamber so that UV light passes through the UV transparent windows and the UV chamber. In FIG. 2 the UV lamps are not illustrated and the UV chamber has been rotated 90° from what is depicted in FIG. 1 to aid in visualization of the UV transparent windows 32. The UV lamps are typically capable of outputting UV radiation having a wavelength range from about 210 to 380 nm. UV-C light such as UV light of germicidal wavelengths has been found particularly effective in exciting the photoinitiator and thereby inducing crosslinking in the thermoplastic polymer. Particularly useful wavelengths are between 200 nm and 280 nm, such as 254 nm. In one embodiment, the UV light source comprises low-pressure mercury germicidal lamps that have an intensity output from about 0.01 to 10 W/cm², and in particular between about 0.025 to 5 W/cm². These lamps are commonly referred to as germicidal since the principal emission is at 254 nm. In other embodiments, the UV chamber may include a UV light source that is internal to the UV chamber, such as a LED UV light. Such an embodiment is discussed in greater detail below. In one embodiment, the UV light source may comprises a UV lamp that is disposed in a UV transparent tube disposed in the interior of the chamber so that the UV light source can be positioned directly or adjacent to the melt stream.

After passing through the UV chamber, the now crosslinked melt stream is introduced into the die where the melt stream is shaped to have a desired shape and configuration. Generally, the die includes one or more orifices through which the melt stream is discharged to form and shape the crosslinked foam. In some embodiments, the melt stream may be extruded in the form of a foam sheet, rod, plank, tube, etc.

FIG. 2 illustrates a cross-sectional side view of an exemplary extruder 12 that may be used in the practice of the invention. In the illustrated embodiment, the extruder includes a barrel 40 equipped with a central primary flow passage 42. An entrance 44 equipped with a hopper 18 is provided at one end of the extruder to facilitate introduction of materials into the primary flow passage. In some embodiments, the apparatus may also include a solid metering feeder (not illustrated).

The barrel 40 is generally heated to a temperature sufficient to melt the material being extruded, and the molten extrudate is forced through the primary flow passage by means of a feedscrew 46. In some embodiments, the extruder may include one or more cooling passages 48 for maintaining the melt stream at a desired temperature. The barrel terminates in flow passageway 28 through which the melt stream is introduced into the UV chamber 14. Upon exiting the flow passageway 28 the melt stream is introduced into the UV chamber 14 and thereafter into die 16. Although not illustrated, in some embodiments the UV chamber can be an integral part of the die. In this embodiment, the UV chamber and die can comprise a single device.

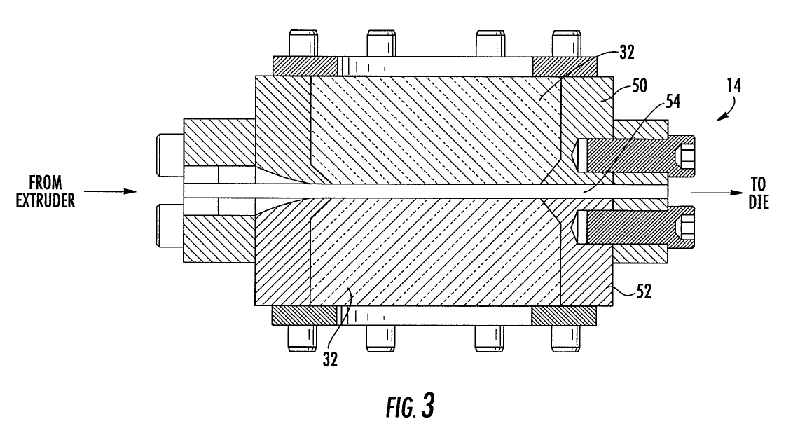

FIG. 3 illustrates an exemplary UV chamber, such as the one depicted in FIGS. 1 and 2. The UV chamber includes a pair of opposing housing members 50, 52 that are attached to each other and define internal passageway 54 therebetween. In the illustrated embodiment, each housing member includes a UV transparent window 32 through which UV light can be directed into internal flow passageway 54. The melt stream passing through the internal flow passageway is exposed to UV light that is introduced into the UV chamber via one or more UV lamps. The UV transparent windows 32 comprise a material, such as quartz, that is transparent to UV light. Generally, the thickness of the UV transparent windows is selected to withstand the pressure under which the melt stream is maintained. For example, the UV transparent windows may have a thickness between about 0.5 and 5 inches, and in particular between about 0.75 and 2.5 inches.

The diameter of the internal passageway within the UV chamber can be selected to control the dosage of UV light to which the melt stream is exposed. For example, a small diameter flow passageway will permit a greater amount of the melt stream to be exposed to the UV light because the melt stream has a relatively narrower cross-sectional diameter. As a result, a greater amount of the melt stream passing through the flow passageway can be exposed to UV light. In contrast, a larger diameter flow passageway will generally limit the UV exposure because the melt stream will have a relatively greater cross sectional diameter that may reduce or hinder the amount of UV light this is capable of penetrating into inner portions of the melt stream. As discussed in greater detail, controlling the UV dosage to which the melt stream is exposed can be used to control the amount of crosslinking in the foam. The inner diameter of the internal flow passageway is generally about 0.05 to 1 inches, and in particular from about 0.1 to 0.35 inches.

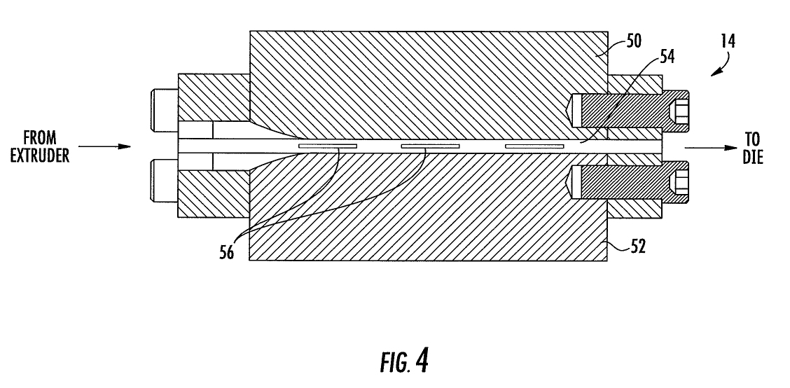

As briefly noted above, the UV chamber may include an internal UV light source. In this regard, FIG. 4 illustrates an embodiment wherein the UV chamber 14 includes one or more LEDs 56 disposed in the interior (e.g., flow passageway 54) of the UV chamber. The LEDs can be disposed adjacent to or within the flow passageway. For example, the UV light source can be placed directly into the melt stream.

In some embodiments, the UV chamber may include a mixing device that is disposed within, or adjacent to, the internal flow passageway 54. The mixing device is capable of mixing the melt stream as it is passing through the UV chamber. Use of the mixing device helps to more uniformly expose the melt stream to the UV light source so that the resulting foam product is more homogenously crosslinked. The apparatus may also include a controller that is operably connected to the UV light source. The controller can be used to selectively control the amount of UV light that is introduced into the melt stream. For example, the controller can varying the dosage of UV light depending upon a number of factors including the desired properties of the foam, residence time of the melt stream in the UV chamber, level of crosslinking agent in the melt stream, the intensity of the UV light source, and the like. Controlling the amount of UV light may provide one method that can be used to selectively control the amount of crosslinking in the polymer.

An important aspect of the present invention is the ability to control the amount of crosslinking in the melt stream by controlling the UV dosage to which the melt stream is exposed. Too much crosslinking in the melt stream can in some cases cause melt fracture and poor foam quality. Too little crosslinking does not provide good foamability. Additionally, light crosslinking in the polymer increases the melt tension and melt viscosity of the polymer, while permitting the polymer to remain flowable. This light crosslinking of the polymer may also permit pressure to build up in the extruder to 400 psig or above without prefoaming which is important in producing a closed cellular structured foam.

Generally, the amount of crosslinking in the foam should be such that the crosslinked polymer has a gel content that is less than about 10%, and in particular less than about 5%. In one embodiment, the crosslinked foam has a gel content of less than 1%. Gel content can be measured with ASTM D 147, the contents of which are hereby incorporated by reference. In one embodiment, the present invention provides a method for preparing a lightly crosslinked foam having a gel content of less than 5% and a melt index of about 0.1 or greater measured in g/10 minute at 2.16 kg and 190° C. Unless otherwise indicated, melt index is measured according to ASTM D 1238, the contents of which are hereby incorporated in their entirety. In one embodiment, the crosslinked melt stream has a high loading melt index less than 30 g/10 min., and in particular between 15 and 30 g/10 min., and more particularly between 20 and 30 g/10 min. As discussed below, a high load melt index can be measured by modifying the ASTM D 1238 using a weight of 21.6 kg with the temperature set at 190° C.

As discussed above, the degree of crosslinking can be controlled by controlling the dosage of UV light to which the melt stream is exposed. In one embodiment, the melt stream is exposed to UV light at a desired wavelength range, at an intensity and residence time sufficient to provide the melt stream with a dose of UV light that is sufficient to induce light crosslinking within the melt stream. Generally, the UV dosage to which the melt stream is exposed is about 0.5 J/cm² or greater, and in particular about 0.5 to 10 mJ/cm². In particular, the melt stream is exposed to a dosage of UV light that is between about 1 and 5 J/cm². In one particular embodiment, the melt stream is exposed to a dosage of UV light that is between about 1 and 2 J/cm², and in particular about 1.25 J/cm².

A wide variety of different thermoplastic polymers may be used in accordance with the invention. Suitable thermoplastic polymers may include polyolefins, such as polyethylenes, polypropylenes, polybutenes, and the like, polyvinyl copolymers, polystyrene, and combinations thereof. Particularly useful polyolefins include low density polyethylene, high density polyethylene, linear low density polyethylene, and combinations thereof. In a particularly useful embodiment, the apparatus may also be used to prepare crosslinked foams comprising polyolefinic resins, such as), ethylene vinyl acetate (EVA) and metallocene catalyzed polyethylenes, polylactic acid based sustainable polymer (PLA polymer), biodegradable polymers, polyesters and thermoplastic polyurethanes that have relatively poor melt strength.

The term “photoinitiator” may include compounds or a class of compounds that upon exposure to UV light are capable of transitioning to an excited state. Generally, the photoinitiator comprises an organic chemical compound that promotes UV-initiated formation of radicals either by intramolecular homolytic bond cleavage or by intermolecular hydrogen abstraction. Such agents may include organic compounds having aryl carbonyl or tertiary amino groups. Among the compounds suitable for use are aromatic ketones such as benzophenone including p,p′-dimethoxybenzophenone, p,p′-dichlorobenzophenone, p,p′-dimethylbenzophenone, 4-chlorobenzophenone, and 4,4′-dichlorobenzophenone; acetophenone; acetonaphthone; benzyl; benzaldehyde; o-chlorobenzaldehyde; xanthone; thioxanthone; 9,10-anthraquinone; 1-hydroxycyclohexyl phenyl ketone; 2,2-diethoxyacetophenone; dimethoxyphenylacetophenone; methyl diethanolamine; dimethylaminobenzoate; 2-hydroxy-2-methyl-1-phenylpropane-1-one; 2,2-di-sec-butoxyacetophenone; 2,2-dimethoxy-1,2-diphenylethan-1-one; benzil dimethoxyketal; benzoin; benzoin methyl ether; phenyl glyoxal; fluorenone, methyl ether, ethyl ether, and the like, and derivatives and combinations thereof. Benzophenone and benzoin ethyl ether may be particularly useful. Other photoinitiators which can be used include aromatic aldehydes such as terephthalaldehyde, and aromatic compounds of quinone series such as methylanthraquinone.

Upon exposure to UV radiation, a variety of photochemical transformations may occur, for example, the photoinitiator may form free radical reactive fragments that react with the crosslinking agent. This initiates crosslinking of the polymer, and may also initiate homopolymerization of the crosslinking agent in embodiments where the crosslinking agent is a multifunctional crosslinking agent. A particularly useful photoinitiator is 1-hydroxycyclohexyl phenyl ketone because of the rapidity with which it generates free radicals when exposed to UV radiation. Mixtures of UV initiators may also be used. This is often desirable because it provides more efficient production of radicals in certain cases. In general, the photoinitiator will be present in an amount of 0.1 to 10.0 weight percent, based on the total weight of the thermoplastic polymer, photoinitiator, and the crosslinking agent. However, the amount of phototinitiator present in the extrudate may vary depending on the desired degree of crosslinking in the thermoplastic polymer. For example, in one embodiment, the amount photoinitiator may range from about 0.1 to 5% by weight, 0.3 to 1% by weight, based on the total weight of the thermoplastic polymer, photoinitiator, and the crosslinking agent.

Suitable UV crosslinking agents may include compounds that form a free radical upon interacting with an excited photoinitiator or that forms a free radical upon being exposed to UV light of sufficient dosage. The resulting free radical of the crosslinking agent is then able to react with the thermoplastic polymer to form a network of crosslinked polymer chains. Suitable crosslinking agents generally include compounds having double or triple bonds and that are capable of forming a free radical upon interacting with an excited photoinitiator, such as styrene-butadiene rubber (SBR), styrene-isoprene-styrene block copolymers (SIS), styrene-butadiene-styrene block copolymers (SBS), ethylene-propylene-diene monomer rubbers (EPDM), polyisobutylene, natural rubber, synthetic polyisoprene, acrylonitrile-butadiene copolymers, polychloroprene, ethylene-vinylacetate, silicones, polyacrylates, triallyl cyanurate (TAC), triallyl isocyanurate, and combinations thereof. Generally, the amount of crosslinking agent in the melt stream is about 0.01 to 5 weight percent based on the weight of the total weight of the thermoplastic polymer, photoinitiator, and crosslinking agent, and in particular between about 0.1 to 1.5, and more particularly between about 0.1 to 1.0 weight percent.

In some embodiments, the thermoplastic polymer can be crosslinked with a multifunctional crosslinking agent that is capable of crosslinking the polymer chains and homopolymerization when exposed to UV light. Such multifunctional crosslinking agents may include vinyl ether, allyl ether, acrylates such as acrylic or methacrylic crosslinking agents, epoxies, and the like. By multifunctional acrylic or methacrylic crosslinking agent is meant an ester that is a reaction product of a polyhydroxylic compound, generally a polyhydroxylic alcohol, and acrylic acid or methacrylic acid, wherein the crosslinking agent has at least two carbon-carbon double bonds. Such compositions are commonly referred to in the art as multifunctional acrylates or multifunctional methacrylates. Typical multifunctional acrylates and methacrylates have molecular weights of 150 to 1,000 and contain at least two polymerizable unsaturated groups per molecule.

Representative multifunctional acrylic crosslinking agents include acrylates and methacrylates such as zinc acrylate, ethylene glycol diacrylate; ethylene glycol dimethacrylate; 1,6-hexanediol diacrylate; 1,6-hexanediol dimethacrylate; 1,4-butanediol diacrylate; pentaerythritol triacrylate; pentaerythritol tetraacrylate; dipentaerythritol pentaacrylate, methoxy-1,6-hexanediolpentaerythritol triacrylate; trimethylolpropane triacrylate; tetraethylene glycol diacrylate; polymethacrylate urethanes; epoxy acrylates; polyester acrylate monomers and oligomers; trimethylolpropane propoxylate triacrylate; poly-n-butyleneoxide glycol diacrylates; and bisphenol A alkylene oxide adduct diacrylates. Additional representative crosslinking agents may include natural rubber, synthetic rubbers like styrene-isoprene-styrene (SIS), styrene-butadiene-styrene (SBS), styrene-butadiene rubber, nitrile rubber, EPDM rubber, saturated carbon chain elastomers, polyether elastomers, thermoplastic elastomers, polyacrylate rubbers, vinylidene polymers, polymers with diene monomers, linear condensation products like polyesters and polyamides.

The multifunctional acrylic and methacrylic crosslinking agents are capable of homopolymerization when exposed to UV radiation. Thus, when the melt stream having a multifunctional crosslinking agent is exposed to UV radiation, two reactions occur. The multifunctional crosslinking agent reacts with the polymer component to form interchain and intrachain crosslinks, resulting in crosslinked matrix. In addition, excess multifunctional crosslinking agent can homopolymerize and form an interpenetrating network which acts to reinforce the matrix.

A wide variety of different foaming agents may be used in the practice of the invention. In one embodiment, the foaming agents used in the composition and processes of the present invention are normally gaseous elements, compounds or mixtures thereof. Some exemplary foaming agents that can be used are listed below. Among the elemental gases that may be employed with satisfactory results are nitrogen, argon, neon, and helium. In addition, normally gaseous organic compounds may be used. Among the more typical of these are the halogen derivatives of methane and ethane, which are used as refrigerants and for similar purposes, such as trichlorofluoromethane (CFC-11); dichlorodifluoromethane (CFC-12); dichlorotetrafluoroethane (CFC-114); difluorotetrachloroethane (CFC-122); chlorodifluoromethane (HCFC-22); 1,1-dichloro 2,2,2-trifluoroethane (HCFC-123); 1-chloro-1,2,2,2 tetrafluoroethane (HCFC-124); 1,1,2,2,2,-pentafluoroethane (HCFC-125); 1,2,2,2,-tetrafluoroethane (HFC-134a); 1,1-dichloro 1-monofluoroethane (HCFC-141b); 1,-chloro-1,1,-difluoroethane (HCFC-142b); 1,1,-difluoroethane (HFC-152a); ethyl chloride; methyl bromide; methyl chloride and the like, and mixtures of any two or more of the above.

Other normally gaseous compounds that may be employed are acetylene, ammonia, butadiene, normal butane, butene, carbon dioxide, nitrous oxide, cyclopropane, dimethylamine, 2-2-dimethyl propane, ethane, ethylene, isobutane, isobutylene, methane, monomethylamine, propane, propylene and trimethylamine.

All of the aforementioned materials are intended to be embraced within the term “normally gaseous, expanding medium” as used herein. This term is intended to mean that the expanding medium employed is a gas at the temperatures existing under the normal operating conditions of a plastic extruder. Also, when reference is made to the introduction of a normally gaseous, expanding medium or a gas into a plastic compound in an extrusion cylinder, it is to be understood that, while the material introduced is a gas at the normal operating temperatures of the extruder, it may be in either gaseous or liquid state at the temperature and pressure at which it is introduced into the extrusion cylinder. It is advantageous to employ foaming agents which are liquids when introduced into the extrusion cylinder because it is easier to pump a liquid under constant pressure and volume than it is to supply a gas under constant pressure and volume.

Examples of liquids which may be used as foaming agents include hydrocarbons, such as: pentane, hexane, heptane or octane; unsaturated hydrocarbons, such as: pentene, 4-methyl pentene, hexene or petroleum ester fractions; ethers such as diethyl ether; alcohols such as: methanol or ethanol; ketones such as: acetone or methyl ethyl ketone; and halogenated hydrocarbons such as: carbon tetrachloride, chloroform, ethylene dichloride, methylene chloride, or 1,1,2-trichloro-1,2,2-trifluoroethane.

Other foaming agents that can be used as supplements to the normally volatile gases are the chemical foaming agents that decompose at elevated temperatures to liberate gases. These foaming agents include: azodicarbonamide, p-toluene sulfonyl hydrazide, dinitrosopentamethylene, mixtures of sodium bicarbonate and citric acid, gypsum, various hydrated aluminas such as aluminum trihydrate, sodium borohydrate and the like.

Foaming agents may be incorporated in amounts from about 0.05 to about 55 percent by weight based on the thermoplastic polymer, and in particular between about 1.0 to 25 percent by weight. Other ingredients such as fillers, stability control agents, antioxidants, antistatic agents, flame retardant additives, nucleation agents, lubricants, foaming aids, coloring agents, and deterioration inhibitors and the like may also be present in the polyolefin composition. Suitable stability control agents may include the partial esters of long-chain fatty acids with polyols, such as those described in U.S. Pat. Nos. 3,644,230 and 3,755,208, as well as higher alkyl amines, fatty acid amides and complete esters of higher fatty acids such as those described in Watanabe et al, U.S. Pat. No. 4,214,054. Typically, such stability control agents are employed in amounts ranging from about 0.1 to about 10 weight percent, based on the weight of the polymer component. Foamable compositions of polyolefins or their copolymers, blowing agents and additives, e.g., stability control agents, antistatic agents, flame retardant agents and the like, are well known in the art and representative examples of such compositions are set forth in U.S. Pat. No. 3,644,230 (Cronin); U.S. Pat. No. 4,214,054 (Watanabe et al.); U.S. Pat. Nos. 4,640,933, 4,633,361 and 4,694,027 (Park), the teachings of which are incorporated herein by reference.

In one embodiment, the crosslinked thermoplastic composition may be expanded to a substantially closed-cell polymeric foam by heat plastifying the polymer resin, admixing with the resin a combination of stability control agents, and foaming agents, and then activating the foaming agents by exposing the admixture to a zone of lower pressure (e.g., atmospheric pressure) to expand the admixture to a substantially closed-cell polymer foam. For example, the invention may be used to produce polyolefin foams having densities in the range of from about 0.5 to about 20 pounds per cubic foot. In other embodiments, the foams may have densities in the range of from about 0.6 to about 15 pounds per cubic foot, and from about 0.9 to 9.0 pounds per cubic foot.

The following examples are provided for the purpose of illustrating one or more embodiments of the invention and are not intended to limit the scope of the invention.

### EXAMPLES

A Haake co-rotating twin-screw extruder was used to blend LDPE (2.3 MI, 0.918 g/cc density) with 1% benzophenone and 3% zinc acrylate (both available from Sigma-Aldrich) at 289° F. Then, the blend was extruded with talc and glycerol monostearate (GMS) aging modifier using a Leistritz 34 mm co-rotating twin-screw extruder (L/D ratio=40 to 1). The extruder was equipped with a capillary die having a diameter of 2 mm. Isobutane was used as the foaming agent to produce the foam samples. The typical melt temperature of the foam was 230° F. The results are shown in the Table 1 below:

TABLE 1
Sample Extrusion Parameters and Foam Properties

| | Output | Isobutane | Die | | | Cell Count | | Hi loading MI |
|---|---|---|---|---|---|---|---|---|
| | rate | Rate | Pressure | Torque | Density | (MD/cMD) | % | (190° C., 21.6 kg) |
| Sample | (lb/hour) | (lb/hr.) | (PSI) | (NM) | (pcf) | (#/inch) | elongation | (g/10 min.) |
| 1 | 8.84 | 0.483 | 336 | 16 | 5.87 | 44/42 | 108 | 31.85 |
| 2 | 8.84 | 0.483 | 750 | 16 | 19.15 | 36/26 | 29 | N/M* |
| 3 | 8.84 | 0.483 | 770 | 16 | 7.58 | 45/45 | 31 | 12.99 |
| 4 | 8.84 | 0.483 | 670 | 16 | 6.25 | 60/55 | 56 | 20.24 |
| 5 | 8.84 | 0.483 | 472 | 16 | 6.3 | 45/34 | 76 | 30.06 |
| 6 | 8.84 | 0.483 | 510 | 16.5 | 6.48 | 43/32 | 73 | 17.60 |
| 7 | 8.84 | 0.483 | 478 | 16.5 | 6.8 | 43/32 | 94 | 34.69 |

*N/M—not measured due to excessive gel content (25% gel)

Table 2 below summarizes the position of the UV light with respect to each sample and the relative amount of UV light that was permitted to be transmitted through the UV transparent window. In the sample runs, a hollow sleeve was positioned between the UV lamp and the transparent window of the UV chamber so that amount of stray UV light was limited. The distance of the UV lamp from the UV chamber was between 11 and 22 inches. The thickness of the transparent window was 1.5 inches so the total distance of the UV lamp from the melt stream is the distance between the UV lamp and the UV chamber plus 1.5 inches. In each sample UV light was introduced into the UV chamber from a single UV lamp positioned on one side of the UV chamber.

TABLE 2
Lamp exposure properties

| | Total distance between | | |
|---|---|---|---|
| | UV light and melt | % Block of Quartz | Lamp Intensity |
| Sample | stream (inches) | window | (W/cm²) |
| 1 | No UV light | n/a | 0 |
| 2 | 12.5 | No block | 0.21 |
| 3 | 23.5 | No block | 0.08 |
| 4 | 23.5 | 50% | 0.04 |
| 5* | 23.5 | 75% | 0.02 |
| 6** | 23.5 | 75% | 0.02 |
| 7 | 1.5 | n/a | 0.0082 |

*vertical block of UV light
**horizontal block of UV light

Ultraviolet (UV) light was used to slightly cross-link the foam samples. The UV light was introduced into the melt stream through a quartz window located is located upstream of the die. The quartz chamber is located between the extruder and the die. For sample 1, no UV light was used and therefore, there is no cross-linking. For samples 2-6, a UV lamp model F300S manufactured by Fusion UV Systems was used. In sample 2, UV light was shown 11 inches away from the quartz window by using a sleeve that is 3 inches in diameter. At that distance, the UV intensity was so high that it produced a poor foam sample with 25% gel content. To optimize cross-linking, the distance between the UV lamp and the quartz window was increased to 22 inches for sample 3 to reduce UV dosage intensity from 0.21 to 0.08 W/cm² (a dosage of about 6 to 2.2 J/cm²). The foam expanded better and the density came down from 19.15 pcf to 7.58 pcf. The UV intensity was further reduced to improve the foaming process further to achieve lower foam density. In sample 4, half of the lamp was blocked to reduce the intensity of the UV light in half. Surprisingly, the cell count increased to 60/55 and gave very fine cell foam. In sample 5, 75% of the lamp was blocked. In sample 7, a different type of UV source with lower intensity was used. It is a CON-TROL-CURE UV LED Linear Array lamp manufactured by UV Process Supply. The residence time of the melt inside the die channel that is exposed to the UV light was calculated according to the following equation:

$$T = \frac{V \cdot ρ}{Q} \qquad ( 1 )$$

where T is the residence time in seconds, V is the die chamber volume, Q is the extruder output rate in lb/hr, and p is the density of the LDPE melt at the foaming temperature of 230° F. The residence time was calculated to be 28.2 seconds using the die chamber volume of 2.38 cubic inches. Appropriate unit conversions were made to calculate the residence time in seconds.

All of the foam samples were tested for gel content using the ASTM D147 method. In all the samples, except 2, the foam samples were lightly crosslinked. No significant amount of gel was detected for samples 3 to 7. To further characterize the amount of crosslinking a melt flow method similar to ASTM D1238 was used to determine the degree of crosslinking in the material. This is an indirect way to show how the viscosity changes due to cross-linking molecular chain entanglement. A high load melt index was measured using a weight of 21.6 kg with the temperature set at 190° C. Sample 1 which did not contain any cross-linking exhibited high melt flow of 31.85 g/10 min. In sample 2, the gel content was measured to be 25% (too high) and no melt flow measurement was made. For samples 3-5, there was more crosslinking observed as the viscosity increased significantly (or melt flow decreased) due to UV intensity increase. In sample 7, the intensity of the LED lamp was significantly smaller than that in Samples 2 through 6, which explains the why a very high MI was measured for this sample. The LED lamp used in sample 7 was positioned adjacent to the surface of the quartz window. As discussed above, the foam in sample 4 had a cell count up to 60 cells/inch at a lamp intensity level of 0.04 W/cm² and a residence time of 28.2 seconds. The intensity level of the lamp used in preparing sample 4 provided good results in producing foams with finer cells with UV induced crosslinking.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of producing a UV induced cross-linked foam comprising:
mixing a composition comprising a thermoplastic polymer, a photoinitiator, and a UV crosslinking agent in a high pressure domain;
heating the composition to form a melt stream;
injecting a foaming agent into the melt stream;
exposing the melt stream to UV light to induce crosslinking in the melt stream; and
extruding the crosslinked melt stream into a low pressure domain to form a thermoplastic foam.

2. The method of claim 1, wherein the step of exposing the melt stream to UV light comprises controlling the dosage of UV light to which the melt stream is exposed so that the resulting thermoplastic foam has a gel content of about less than 5% by weight.

3. The method of claim 2, wherein the gel content is less than 1% by weight.

4. The method of claim 1, wherein melt stream is exposed to a dosage of UV light that is between about 0.5 and 5 J/cm².

5. The method of claim 1, wherein melt stream is exposed to a dosage of UV light that is between about 1 and 2 J/cm².

6. The method of claim 1, further comprising the step of passing the melt stream through a UV chamber in which the melt stream is exposed to UV light.

7. The method of claim 6, wherein a UV light source is disposed in or adjacent to the UV chamber.

8. The method of claim 7, further comprising passing the melt stream through a flow passageway in the UV chamber and wherein a portion of the flow passageway comprises a UV transparent material through which the UV light is introduced into the melt stream.

9. The method of claim 8, further comprising a UV light source that is located outside of the UV chamber and is positioned and arranged to direct UV light through the UV transparent material and into the melt stream.

10. The method of claim 6, further comprising the step of mixing the melt stream as it passes through the UV chamber.

11. The method of claim 1, wherein the photoinitiator comprises benzophenone, acetophenone, acetonaphthone, benzyl, benzaldehyde, o-chlorobenzaldehyde, xanthone, quinines thioxanthone and benzoin, and derivative and combinations thereof.

12. The method of claim 1, wherein the amount of photoinitiator in the composition is from about 0.1 to 5% by weight, based on the total weight of the thermoplastic polymer, photoinitiator, and the UV crosslinking agent.

13. The method of claim 1, wherein the amount of UV crosslinking agent comprises a compound having a double or triple bond and that is capable of generating a free radical upon interacting with the photoinitiator when the photoinitiator is in an excited state.

14. The method of claim 1, wherein the amount of UV crosslinking agent comprises styrene-butadiene rubber, styrene-isoprene-styrene block copolymers, styrene-butadiene-styrene block copolymers, ethylene-propylene-diene monomer rubbers, polyisobutylene, natural rubber, synthetic polyisoprene, acrylated rubbers, acrylonitrile-butadiene copolymers, polychloroprene, ethylene-vinylacetate, silicones, polyacrylates, triallyl cyanurate, triallyl isocyanurate, and combinations thereof.

15. The method of claim 1, wherein the UV crosslinking agent comprises vinyl ether, allyl ether, acrylates, acrylate/methacrylate resins, zinc acrylate, diacrylates, polymers formed from diene monomers, and derivatives and combinations thereof.

16. A method of producing a UV induced cross-linked foam comprising:
mixing a composition comprising a thermoplastic polymer, a photoinitiator, a UV crosslinking agent and a foaming agent under heat and pressure to form a melt stream;
introducing UV light into the melt stream to excite the photoinitiator;
interacting the excited photoinitiator with the UV crosslinking agent to generate a free radical on the UV crosslinking agent;
crosslinking the thermoplastic polymer with the UV crosslinking agent; and
extruding the crosslinked thermoplastic polymer into a low pressure domain to form a thermoplastic foam, and wherein a dosage of UV light introduced into the melt stream is from about 0.5 to 10 mJ/cm².

17. The method of claim 16, wherein the UV dosage to which the melt stream is exposed is selected so that the thermoplastic foam has a gel content of less than 1% by weight and a high loading melt index of less than about 30 g/10 minutes.

18. The method of claim 16, wherein melt stream is exposed to a dosage of UV light that is between about 1.25 J/cm².

19. The method of claim 16, further comprising the step of passing the melt stream through a UV chamber in which the melt stream is exposed to a UV light source that is located outside of the UV chamber and is positioned and arranged to direct UV light into the UV chamber.

20. The method of claim 16, wherein the step of introducing UV light into the melt stream comprises passing the melt stream in close proximity to a UV light source that is positioned and arranged to be disposed within the melt stream.

21. The method of claim 20, wherein the UV light source comprises an LED UV light.

22. The method of claim 16, wherein the photoinitiator comprises benzophenone, acetophenone, acetonaphthone, benzyl, benzaldehyde, o-chlorobenzaldehyde, xanthone, quinines thioxanthone and benzoin, and derivatives and combinations thereof, and the UV crosslinking agent comprises an acrylate.

23. A apparatus for extruding a crosslinked polymeric foam, the apparatus comprising:
an extruder for mixing and melting a polymeric composition to form a melt stream;
a die having an exit orifice through which the melt stream is discharged from the apparatus; and
a UV light source disposed between the extruder and the die, the UV light source being configured and arranged to direct UV light into the melt stream.

24. The apparatus of claim 23, further comprising a UV chamber disposed between the die and the extruder, wherein the UV chamber includes one or more UV transparent windows through which UV light can be introduced into the melt stream.

25. The apparatus of claim 24, wherein the UV chamber is an integral part of the die.

26. The apparatus of claim 24, wherein the UV light source comprises a germicidal mercury lamp.

27. The apparatus of claim 23, wherein the UV light source is disposed in the melt stream.

28. The apparatus of claim 23, wherein the UV light source comprises an LED light.

29. The apparatus of claim 23, further comprising a mixing device that is disposed near the UV chamber and is configured and arranged to mix the melt stream as it passes through the UV chamber.
